(19) United States
(12) Patent Application Publication
(10) Pub. No.: US 2023/0087395 A1
(43) Pub. Date: Mar. 23, 2023

(54) DOMAIN ADAPTATION SYSTEM AND METHOD FOR IDENTIFICATION OF SIMILAR IMAGES

(71) Applicant: Myntra Designs Private Limited, Muneshwara Nagar (IN)

(72) Inventors: Sumit Borar, Bangalore (IN); Vikram Garg, Jaipur (IN); Anoop Rajagopal, Bangalore (IN); Rajdeep Hazra Banerjee, Bangalore (IN)

(21) Appl. No.: 17/994,245

(22) Filed: Nov. 25, 2022

Related U.S. Application Data
(63) Continuation of application No. 16/731,329, filed on Dec. 31, 2019, now abandoned.

(30) Foreign Application Priority Data
Mar. 8, 2019 (IN) 201941009186

(51) Int. Cl. G06K 9/62; G06Q 30/06; G06V 10/75

(52) U.S. Cl. CPC G06K 9/6215; G06Q 30/0643; G06K 9/6255; G06K 9/6276; G06V 10/751

(57) ABSTRACT

A domain adaptation system and method for identifying similar images of fashion products is provided. The system includes a memory having computer-readable instructions stored therein and a processor. The processor is configured to access a plurality of source images of a plurality of fashion products. The processor is further configured to access a plurality of target images of the plurality of fashion products. The processor is configured to process the source images and the target images to determine one or more domain invariant features from the source and target images. Further, the processor is configured to identify one or more substantially similar images from the source images and the target images based upon the one or more domain invariant features.

### PRIORITY STATEMENT

The present application hereby is a continuation of U.S. patent application Ser. No. 16/731,329, filed Dec. 31, 2019, which claims priority to Indian Patent Application No. 201941009186 filed on Mar. 8, 2019, the entire contents of which are hereby incorporated herein by their reference.

### FIELD

The invention generally relates to the field of domain adaptation and more particularly to a system and method for identifying similar images of fashion products across different domains.

### BACKGROUND

In the domain of fashion industry, the styles are ever changing with varying individual tastes, seasons, geographies, among other interdependent factors. Brands quickly need to identify changing customer preferences and bring in new designs for the customers. Generating new images and designs significantly aid the ever-increasing customer demands. Various generative models have been used for image generation. Image generative models such as Generative Adversarial Networks (GAN) generate real looking artificial images by training neural networks using machine learning techniques.

In image generation, deep neural networks are trained to extract high-level features on natural images to reconstruct the images from the features. Such generative models may produce a large set of duplicate data or images. Deduplication of images using generative image models is challenging as there is a large difference in image characteristics due to the shift in domain. Moreover, images used on various fashion e-commerce platforms are imaged under diverse settings in terms of background, lighting conditions, ambience, model shoots and the like. As a result, images exhibit different data distributions across different domains which makes it difficult to identify similar images and gives rise to various other problems.

Domain adaptation is a step towards overcoming the dataset domain shift across different domains by reducing the gap among them. The techniques involve the process of adapting one or more source domains for the means of transferring information to improve the performance of a target learner. The domain of labeled training data is termed as source domain, and the test dataset is called target domain.

However, the current domain adaptation techniques and deduplication solutions (dedup) have mostly adopted supervised methods and use annotations and labels to train the models. Such annotations are prohibitively time-consuming and expensive. Many recent works in case of unsupervised adaptation methods are specific to certain domains.

Thus, there is a need for an unsupervised domain adaptation method to identify similar images to address the problem of image dedup across e-commerce platforms.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide system and method for identification of similar images across various domains.

Briefly, according to an example embodiment, a domain adaptation system for identifying similar images of fashion products is provided. The system includes a memory having computer-readable instructions stored therein and a processor. The processor is configured to access a plurality of source images of a plurality of fashion products. The processor is further configured to access a plurality of target images of the plurality of fashion products. Further, the processor is configured to process the source images and the target images to determine one or more domain invariant features from the source and target images. The processor is configured to identify one or more substantially similar images from the source images and the target images based upon the one or more domain invariant features.

According to another example embodiment, a domain adaptation system for identifying similar images of fashion products is provided. The system includes a memory having computer-readable instructions stored therein. The system further includes a processor configured to access a plurality of source images of a plurality of fashion products. In addition, the processor is configured to access a plurality of target images of the plurality of fashion products. The processor is further configured to embed feature data from the source images and the target images using autoencoder. The processor is configured to determine one or more domain invariant features for the source and the target images using the feature data based on domain classification with adversarial loss. Furthermore, the processor is configured to identify one or more substantially similar images from the source images and the target images based upon the one or more domain invariant features.

In a further embodiment, a method for identifying similar images of fashion products across different domains is provided. The method includes accessing a plurality of source images of a plurality of fashion products. The method further includes accessing a plurality of target images of the plurality of fashion products. The method further includes processing the source images and the target images to determine one or more domain invariant features of the source and target images. Furthermore, the method includes identifying one or more substantially similar images from the source images and the target images based upon the one or more domain invariant features.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of one embodiment of a domain adaptation system for identification of similar images of fashion products, implemented according to the aspects of the present technique.

FIG. 2 illustrates one example embodiment of determining domain invariant features of fashion images across different domains using the domain adaptation platform, of FIG. 1, implemented according to the aspects of the present technique;

FIG. 3 illustrates an example process to identify similar images of fashion products across different domains, implemented according to the aspects of the present technique;

FIG. 4 is an example graph illustrating domain and reconstruction loss during training of the network, using the domain adaptation system of FIG. 1;

FIG. 5-A illustrates a t-sne plot using original features f_{vgg} and source (catalogue) images of fashion products;

FIG. 5-B illustrates t-sne plot for CORAL features f_{coral} and source (catalogue) images of fashion products;

FIG. 5-C illustrates t-sne plot for domain adapted features f_{da} (510) and source (catalogue) images of fashion products; and

FIG. 6 is a block diagram of an embodiment of a computing device in which the modules of the domain adaptation system for identifying similar images of fashion products, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled”. Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

At least one example embodiment is generally directed to an unsupervised domain adaptation system and method for identification of similar images of fashion products across various domains such as catalogues and e-commerce platforms. It should be noted that the techniques described herein may be applicable to a wide variety of images of the fashion products available on e-commerce platforms.

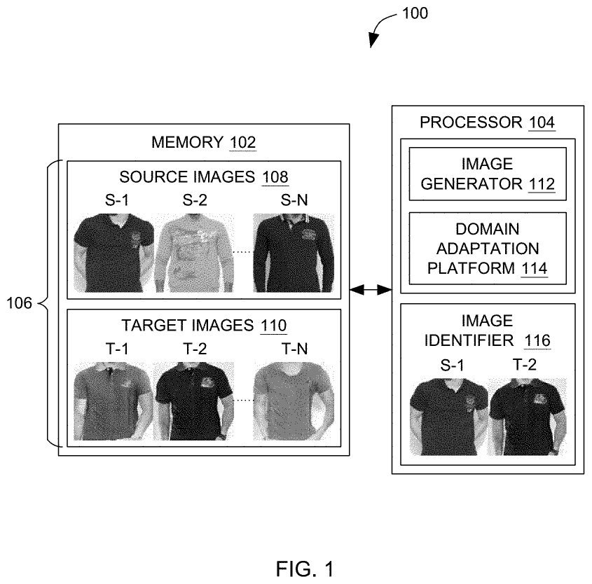

FIG. 1 is a block diagram of one embodiment of a domain adaptation system 100 for identification of similar images of fashion products, implemented according to the aspects of the present technique. The system 100 includes a memory 102 and a processor 104. Each component is described in further detail below.

As illustrated, the processor 104 is communicatively coupled to the memory 102 and is configured to access a plurality of fashion images 106 of a variety of fashion products. In this example, the fashion images 106 include a plurality of source images 108 (S-1 through S-N) and a plurality of target images 110 (T-1 through T-N) of fashion products such as t-shirts as illustrated herein. In an embodiment, the fashion images 106 may include images of such fashion products available for sale on an e-commerce fashion platform. In one example, the fashion images 106 may include images of a top wear, a bottom wear, footwear, bags, or combinations thereof.

The processor 104 is configured to access the plurality of source images 108 of the plurality of fashion products. In this example, the source images 108 include images of fashion products available for sale on a first e-commerce platform. Further, the target images 110 include images of fashion products available for sale on a second e-commerce platform. Alternately. the target images 110 may include images generated from the source images 106 using a generative model.

In this example, the processor 104 includes an image generator 112 configured to generate the target images 110 from the source images 108 using a generative model such as Generative Adversarial Networks (GAN). The target images 110 generated from the source images 108 are stored and accessed from the memory 102 of the system 100.

The processor 104 further includes a domain adaptation platform 114. The domain adaptation platform 114 is configured to embed feature data from the source images 108 and the target images 110 using autoencoder to generate representative feature data. In this example, the feature data may include generic high-level features from the source images 110 and the target images 112. Moreover, domain adaptation platform 114 is configured to determine one or more domain invariant features using the representative feature data based on domain classification with adversarial loss. In this example, the one or more domain invariant features are determined using a trained convolutional neural network.

In one example, the domain adaptation platform 114 is configured to determine the one or more domain invariant features by reducing an adversarial loss. In this example, the adversarial loss is estimated in accordance with the following relationship:

$$E ( {ϕ}_{enc} , {ϕ}_{dec} , {ϕ}_{dom} ) = \frac{1}{N} {\sum }_{i}^{N} {L}_{rec}^{i} - λ ( \frac{1}{{N}_{1}} {\sum }_{i = 1}^{N 1} {L}_{dom}^{i} + \frac{1}{{N}_{2}} {\sum }_{i = 1}^{{N}_{2}} {L}_{dom}^{i} ) \qquad Equation ( 1 )$$

### Where:

φ_{enc}, φ_{dec} are parameters of the encoder and decoder in the autoencoder;
φ_{dom} are parameters of a classifier layer;
L_{rec} and L_{dom} are reconstruction loss and classifier loss respectively; and
λ is a hyper-parameter used to obtain the saddle points (ϕ_{enc}, ϕ_{dec}, ϕ_{dom})

The processor further includes an image identifier 116. In one example embodiment, the image identifier 118 is configured to identify one or more substantially similar images from the source images 108 and the target images 110 based upon the one or more domain invariant features. For example, S-1 and T-2 are identified as similar images by the image identifier 116. In some examples, the similar or duplicate images such as T-2 may be removed from the e-commerce platform. In this example, one or more similar/duplicate images from the source images 108 and the target images 110 are identified using k-nearest neighbors (KNN) algorithm.

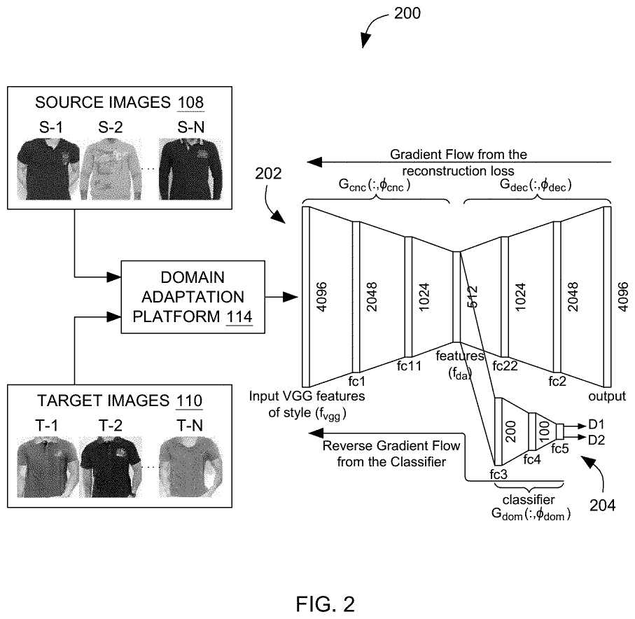

FIG. 2 illustrates one example embodiment of determining domain invariant features of fashion images across different domains using the domain adaptation platform 114, of FIG. 1, implemented according to the aspects of the present technique. As illustrated, the domain adaptation platform 114 accesses the source and target images 108 and 110. In this embodiment, domain adaptation is performed using autoencoder and a classifier with adversarial loss generally represented by reference numerals 202 and 204 respectively. In an embodiment, feature data from the source images 110 and the target images 112 are embedded using the autoencoder to generate representative feature data. In this embodiment, the feature data may be generic high-level features from the source images 110 and the target images 112.

In a further embodiment, one or more domain invariant features are determined using the representative feature data based on domain classification with adversarial loss. In this example, the one or more domain invariant features are determined using a trained convolutional neural network.

For example, in the illustrated embodiment, {xᵢ∈ [symbol] ^{d}}ᵢ₌₁^{N} represents the pooled source and target image data and {yᵢ}ᵢ₌₁^{N} represents their respective domain labels, where yᵢ531 {S, T}. As illustrated, ϕ_{enc}, ϕ_{dec} are the parameters of the autoencoder and ϕ_{dom} represents the parameters of the classifier layer. In addition, G_{dec}, G_{enc} and G_{dom} are the respective functions of decoder, encoder and classifier layers. In this example, the parameters ϕ_{enc} correspond to the that maximise the loss of the domain classifier and ϕ_{dom} corresponds to the parameters that minimise the loss of domain classifier. Also the parameters ϕ_{enc} and ϕ_{dec} are used to minimise the reconstruction loss L_{rec}. In this example, the reconstruction loss is calculated in accordance with the relationship:

L_{rec}ⁱ(ϕ_{enc},ϕ_{dec})=L(G_{dom}(G_{enc}(xᵢ;ϕ_{enc})ϕ_{dec}),xᵢ) Equation (2)

where L_{rec} is a L1 loss function between the input and the output of the autoencoder. In this embodiment, the classifier loss L_{dom}ⁱ. is calculated using binary cross entropy in accordance with the relationship:

L_{dom}ⁱ(ϕ_{enc},ϕ_{dom})=L(G_{dom}(G_{enc}(xᵢ;ϕ_{enc});ϕ_{dom}),yᵢ) Equation (3)

In another embodiment, an adversarial loss is estimated in accordance with the relationship:

$$E ( {ϕ}_{enc} , {ϕ}_{dec} , {ϕ}_{dom} ) = \frac{1}{N} {\sum }_{i}^{N} {L}_{rec}^{i} - λ ( \frac{1}{{N}_{1}} {\sum }_{i = 1}^{N 1} {L}_{dom}^{i} + \frac{1}{{N}_{2}} {\sum }_{i = 1}^{{N}_{2}} {L}_{dom}^{i} ) \qquad Equation ( 4 )$$

### Where:

φ_{enc}, φ_{dec} are parameters of the encoder and decoder in the autoencoder;

φ_{dom} are parameters of a classifier layer;

L_{rec} and L_{dom} are reconstruction loss and classifier loss respectively; and

λ is a hyper-parameter used to obtain the saddle points (ϕ_{enc}, ϕ_{dec}, ϕ_{dom}).

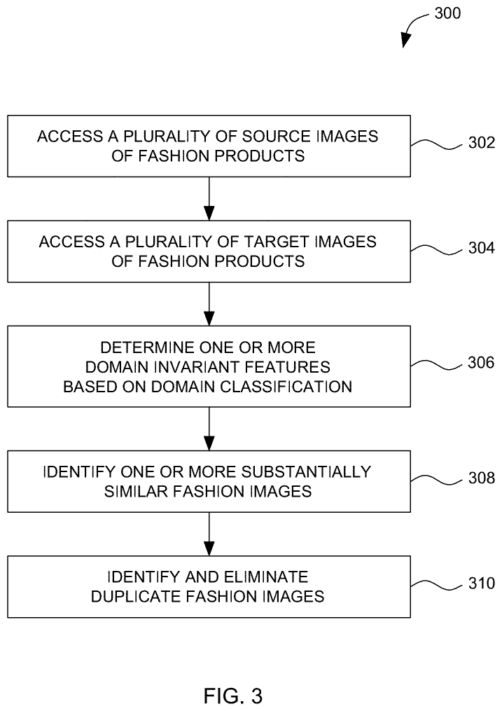

In an example embodiment, the adversarial loss such as estimated above, is optimized using backpropagation with the Gradient Reversal Layer between the encoder and classifier. In this example, the Gradient Reversal Layer during the forward pass acts as an identity layer and during backward passes it multiplies the gradient from subsequent layer by −λ. and passes to preceding layer for updates. It may be noted that one or more domain invariant features are determined based on domain classification with adversarial loss using a trained convolutional neural network. The manner in which the duplicate images across different domains are identified using the domain adaptation system 100 of FIG. 1, is described with reference to FIG. 3.

FIG. 3 illustrates an example process 300 to identify similar images of fashion products across different domains, implemented according to the aspects of the present technique.

At block 302, a plurality of source images (e.g., 108) stored in the memory 102 are accessed. In this example, a plurality of source images 108 (S-1 through S-N) include images of a plurality of fashion products available for sale on a first e-commerce fashion platform. In an embodiment, the fashion products may include a top wear, a bottom wear, footwear, bags or combinations thereof.

At block 304, a plurality of target images (e.g., 110) of fashion products are accessed from the memory 102. In this example, the target images 110 may be available for sale on a second e-commerce platform. In one embodiment, the target images 110 are generated from the source images 108 using a generative model. In this embodiment, the target images 110 are generated from the source images 108 using Generative Adversarial Networks (GAN).

At block 306, one or more domain invariant features are determined. In one embodiment, feature data from the source images 108 and the target images 110 is embedded using autoencoder to generate representative feature data. In this example, the feature data may include generic high-level features from the source images 108 and the target images 110. Further, one or more domain invariant features are determined using the representative feature data based on domain classification with adversarial loss. In this example, the one or more domain invariant features are determined using a trained convolutional neural network.

At block 308, one or more substantially similar images (e.g., S-1 and T-2) are identified. In an embodiment, one or more substantially similar images are identified from the source images 108 and the target images 110 based upon the one or more domain invariant features.

At block 310, one or more duplicate images from the source images 108 and the target images 110 are identified using KNN algorithm. In a further embodiment, the identified duplicate images are eliminated from the target images 110.

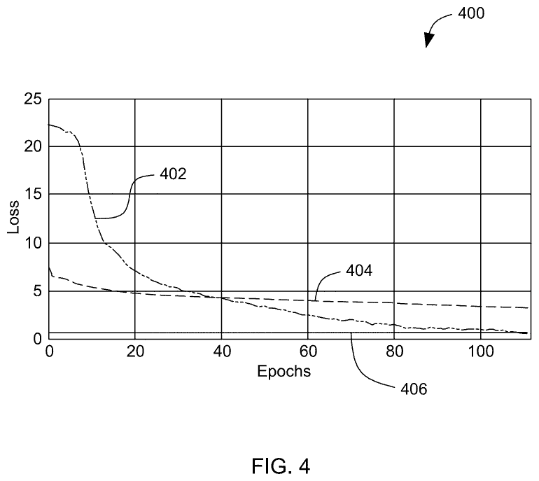

FIG. 4 is an example graph 400 illustrating domain and reconstruction loss during training of the network, using the domain adaptation system 100 of FIG. 1. In this example, about 44000 images of fashion product (t-shirt in this case) from a catalogue were used as the source images. Moreover, a DCGAN model is trained to generate target images using the source images from the catalogue. For the training, a learning rate was about 0.0008 and Adam optimizer (beta1=0.5) was used to generate images of size 256λ256.

Further, a set of 20000 images were used from the catalogue (source images) and GAN generated (target) images. In this example, about 4096 length feature vectors for each image were calculated using the VCG-16 pretrained network that were subsequently passed into the network. In the illustrated embodiment, the domain loss and the reconstruction loss are indicated by reference numerals 402 and 404 respectively. Further, the optimum domain loss is indicated by reference numeral 406.

As can be seen, both the domain and the reconstruction losses 420 and 404 decrease with epochs indicating good convergence. In this example, the domain loss saturates to an optimum point as depicted by 406. In addition, the optimum domain classification loss is when the classifier unit outputs 0.5, the binary cross entropy loss then turns out to be ln(0.5). It may be noted that the scale of domain and reconstruction losses are different. In one embodiment, the encoded fully connected layer f_{da} is extracted as per domain adapted feature representation.

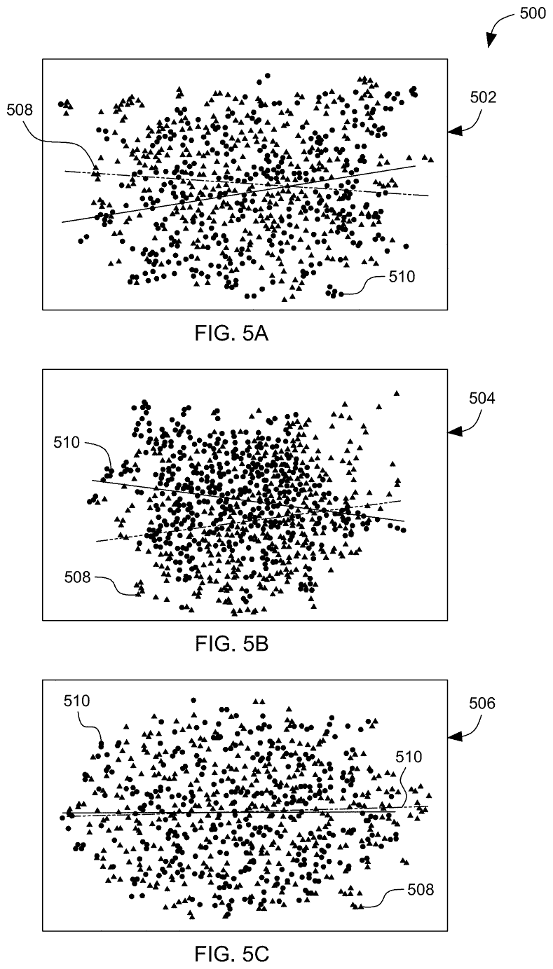

FIG. 5-A through FIG. 5-C are example graphs illustrating t-sne plots of original features f_{vgg}, state-of-the art CORAL f_{coral} and domain adapted features f_{da}. FIG. 5-A illustrates t-sne plot 502 using original features f_{vgg} and catalog images. The lines indicate the principal directions. In an embodiment, domain adapted f_{da} (510), feature representation with VGG f_{vgg} (508) features as our baseline. FIG. 5-B illustrates t-sne plot 504 for CORAL features f_{coral} and source (catalogue) images. In an embodiment, the source and target image data sets have two different principal directions for the original f_{vgg} (508) and f_{coral} features respectively. This indicates that the data distribution of source and target images are very different. However, in FIG. 5-C, for the domain adapted features f_{da} (510), the principal directions are well aligned for both the source and target image data sets. In another embodiment, KL divergence between the domains using f_{vgg}, f_{coral} and f_{da} is calculated. In this example, the data from both domains come from multivariate normal distribution.

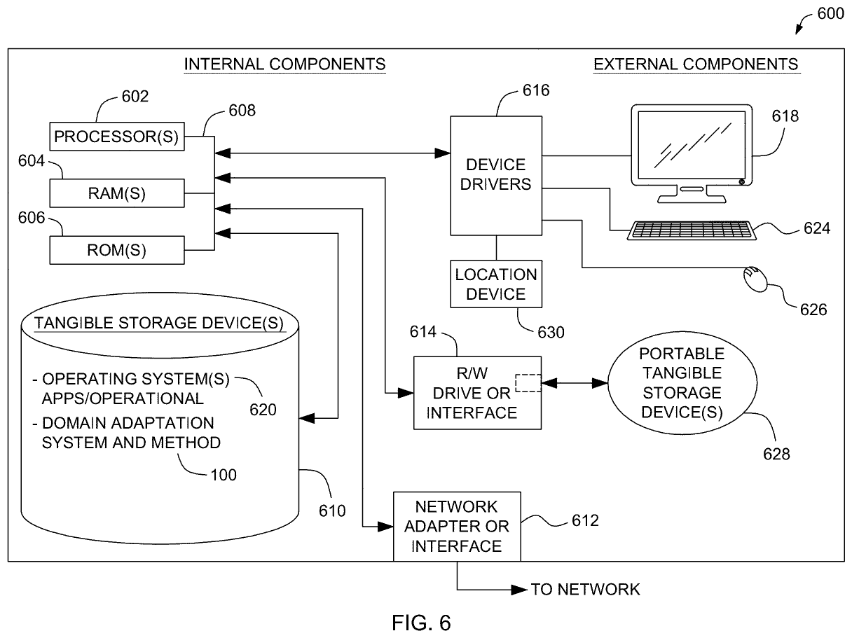

The modules of the domain adaptation system 100 for generating images of fashion products, described herein are implemented in computing devices. One example of a computing device 600 is described below in FIG. 6. The computing device includes one or more processor 602, one or more computer-readable RAMs 604 and one or more computer-readable ROMs 606 on one or more buses 608. Further, computing device 600 includes a tangible storage device 610 that may be used to execute operating systems 620 and the domain adaptation system 100. The various modules of the domain adaptation system 100 includes a memory 102 and a processor 104. The processor 104 further includes an image generator 114, a feature extractor 116 and an image identifier 118. Both, the operating system 620 and the domain adaptation system 100 are executed by processor 602 via one or more respective RAMs 604 (which typically includes cache memory). The execution of the operating system 620 and/or the system 100 by the processor 602, configures the processor 602 as a special purpose processor configured to carry out the functionalities of the operation system 620 and/or the domain adaptation system 100, as described above.

Examples of storage devices 610 include semiconductor storage devices such as ROM 606, EPROM, flash memory or any other computer-readable tangible storage device that may store a computer program and digital information.

Computing device also includes a R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless Wi-Fi interface cards, or 3G or 4G wireless interface cards or other wired or wireless communication links are also included in computing device.

In one example embodiment, domain adaptation system 100 includes a memory 102 and a processor 104. The processor 104 further includes an image generator 114, a feature extractor 116 and an image identifier 118. The system 100 may be stored in tangible storage device 610 and may be downloaded from an external computer via a network (for example, the Internet, a local area network or other, wide area network) and network adapter or interface 612.

Computing device further includes device drivers 616 to interface with input and output devices. The input and output devices may include a computer display monitor 618, a keyboard 624, a keypad, a touch screen, a computer mouse 626, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A domain adaptation system for identifying similar images of fashion products, the system comprising:
a memory having computer-readable instructions stored therein; and
a processor configured to:
access a plurality of source images of a plurality of fashion products;
access a plurality of target images of the plurality of fashion products;
process the source images and the target images to determine one or more domain invariant features from the source and target images; and
identify one or more substantially similar images from the source images and the target images based upon the one or more domain invariant features.

2. The domain adaptation system of claim 1, wherein the processor is further configured to execute the computer-readable instructions to access a plurality of fashion images of a top wear, a bottom wear, foot wear, bags, or combinations thereof.

3. The domain adaptation system of claim 1, wherein the processor is further configured to:
access the source images of fashion products available for sale on a first e-commerce fashion platform; and
access the target images of fashion products available for sale on a second e-commerce fashion platform.

4. The domain adaptation system of claim 3, wherein the processor is further configured to:
access the source images available for sale on the first e-commerce fashion platform; and
generate the target images from the source images using a generative model.

5. The domain adaptation system of claim 4, wherein the processor is further configured to execute the computer-readable instructions to generate the target images from the source images using Generative Adversarial Networks (GAN).

6. The domain adaptation system of claim 1, wherein the processor is further configured to execute the computer-readable instructions to:
embed feature data from the source images and the target images using autoencoder; and
determine the one or more domain invariant features using the feature data based on domain classification with adversarial loss.

7. The domain adaptation system of claim 6, wherein the processor is further configured to execute the computer-readable instructions to determine the one or more domain invariant features using a trained convolutional neural network.

8. The domain adaptation system of claim 7, wherein the processor is further configured to execute the computer-readable instructions to reduce an adversarial loss to determine the one or more domain invariant features, wherein the adversarial loss is estimated in accordance with the relationship:
$$E ( {∅}_{enc} , {∅}_{dec} , {∅}_{dom} ) = \frac{1}{N} {\sum }_{i}^{N} {L}_{rec}^{i} - λ ( \frac{1}{N 1} {\sum }_{i}^{N 1} {L}_{dom}^{i} ) + \frac{1}{N 2} {\sum }_{i}^{N 2} {L}_{dom}^{i} ;$$
where
φ_{enc}, φ_{dec} are parameters of the encoder and decoder in the autoencoder;
φ_{dom} are parameters of a classifier layer; and
L_{rec} and L_{dom} are reconstruction loss and classifier loss respectively.

9. The domain adaptation system of claim 1, wherein the processor is further configured to execute the computer-readable instructions to identify one or more substantially similar images from the source images and the target images using k-nearest neighbors (KNN) algorithm.

10. The domain adaptation system of claim 9, wherein the processor is further configured to execute the computer-readable instructions to:
identify one or more duplicate images from the source images and the target images using the KNN algorithm; and
eliminate the identified duplicate images from the target images.

11. A domain adaptation system for identifying similar images of fashion products, the system comprising:
a memory having computer-readable instructions stored therein; and
a processor configured to:
access a plurality of source images of a plurality of fashion products;
access a plurality of target images of the plurality of fashion products;
embed feature data from the source images and the target images using autoencoder;
determine one or more domain invariant features for the source and the target images using the feature data based on domain classification with adversarial loss; and
identify one or more substantially similar images from the source images and the target images based upon the one or more domain invariant features.

12. The domain adaptation system of claim 11, wherein the processor is further configured to execute the computer-readable instructions to optimize an adversarial loss of the domain classification using backpropogation to determine the one or more domain invariant features.

13. The domain adaptation system of claim 11, wherein the processor is further configured to execute the computer-readable instructions to access a plurality of fashion images of a top wear, a bottom wear, foot wear, bags, or combinations thereof.

14. The domain adaptation system of claim 11, wherein the processor is further configured to:
access the source images available for sale on the first e-commerce fashion platform; and
generate the target images from the source images using a generative model.

15. The domain adaptation system of claim 11, wherein the processor is further configured to execute the computer-readable instructions to identify one or more substantially similar images from the source images and the target images using k-nearest neighbors (KNN) algorithm.

16. A method for identifying similar images of fashion products across different domains, the method comprising:
accessing a plurality of source images of a plurality of fashion products;
accessing a plurality of target images of the plurality of fashion products;
processing the source images and the target images to determine one or more domain invariant features of the source and target images; and
identifying one or more substantially similar images from the source images and the target images based upon the one or more domain invariant features.

17. The method of claim 16, wherein accessing the source images and the target images further comprises:
accessing the source images for fashion products available for sale on a first e-commerce fashion platform; and
generating the target images from the source images using a generative model.

18. The method of claim 17, wherein processing the source images and the target images further comprises:
embedding feature data from the source images and the target images using autoencoder to generate representative feature data; and
processing the representative feature data based on domain classification with adversarial loss to determine the one or more domain invariant features;

19. The method of claim 18, further comprising determining the one or more domain invariant features using a trained convolutional neural network.

20. The method of claim 16, further comprising:
identifying one or more duplicate images from the source images and the target images using the KNN algorithm; and
eliminating the identified duplicate images from the target images.
